(19) United States
(12) Patent Application Publication
(10) Pub. No.: US 2011/0052133 A1
(43) Pub. Date: Mar. 3, 2011

(54) FIBER ORGANIZER TRAY AND TELECOMMUNICATIONS ENCLOSURE

(75) Inventors: Richard L. Simmons, Leander, TX (US); Joseph M. Van Allen, Cedar Park, TX (US); Jeremy K. Zoss, San Antonio, TX (US); Jason C. Nave, San Antonio, TX (US)

(73) Assignee: 3M Innovative Properties Company

(21) Appl. No.: 12/870,015

(22) Filed: Aug. 27, 2010

Related U.S. Application Data
(60) Provisional application No. 61/238,450, filed on Aug. 31, 2009.

(51) Int. Cl. G02B 6/00

(52) U.S. Cl. 385/135

(57) ABSTRACT

A fiber organizer tray comprises a generally rectangular or oblong body having a first side and an opposite second side. The first side is configured to route and provide slack storage for a plurality of jacketed cables. The first side includes a winding cable guide that routes multiple jacketed cables a predetermined distance in a manner in which the multiple jacketed cables do not cross over themselves and do not experience a cable bend that violates a minimum bend radius of an optical fiber portion of the jacketed cable. The second side of the organizer tray is configured to route and splice a plurality of the drop cables to a plurality of optical fiber pigtails. The fiber organizer tray can be implemented in a telecommunication enclosure having a distribution management unit and a jacketed cable management unit disposed therein. The telecommunication enclosure can be configured as a fiber distribution terminal (FDT) for managing telecommunication lines, especially optical fiber telecommunication lines, in a building, such as an MDU or other location.

### CROSS REFERENCE TO RELATED APPLICATION

This application claims the benefit of U.S. Provisional Patent Application No. 61/238,450, filed Aug. 31, 2009, the disclosure of which is incorporated by reference herein in its entirety.

### BACKGROUND OF THE INVENTION

1. Field of the Invention

The present invention is directed to a fiber organizer tray and a telecommunication enclosure, preferably a fiber distribution terminal, having one or more fiber organizer trays disposed therein, for managing telecommunication lines, especially optical fiber telecommunication lines, in a building or other structure.

2. Background

Several hundred million multiple dwelling units (MDUs) exist globally, which are inhabited by about one third of the world's population. Due to the large concentration of tenants in one MDU, Fiber-to-the-X (“FTTX”) deployments to these structures are more cost effective to service providers than deployments to single-family homes. Connecting existing MDUs to the FTTX network can often be difficult. Challenges can include limited distribution space in riser closets and space for cable routing and management.

Conventionally, a service provider installs an enclosure at a main access point in a building (often called a fiber distribution hub (FDH)) which couples service fibers to a riser cable that delivers the fibers to a terminal (known as a fiber distribution terminal (FDT)) installed on each floor, or every few floors, of an MDU or multiple tenant unit (MTU). The FDT connects the building riser cable to the horizontal drop cables which run to each living unit on a floor. The FDH enclosure is usually owned and installed by the service provider.

### SUMMARY

According to an exemplary aspect of the present invention, a fiber organizer tray comprises a generally rectangular or oblong body having a first side and an opposite second side. The first side is configured to route and provide slack storage for a plurality of jacketed cables. The first side includes a winding cable guide that routes multiple jacketed cables a predetermined distance in a manner in which the multiple jacketed cables do not cross over themselves and do not experience a cable bend that violates a minimum bend radius of an optical fiber portion of the jacketed cable.

In another aspect, the second side is configured to route and splice a plurality of the jacketed cables to a plurality of optical fiber pigtails. In yet another aspect, the second side comprises a splice management insert configured to secure multiple splices formed between the optical fiber pigtails and the plurality of jacketed cables.

In another aspect, the fiber organizer tray further comprises an opening formed in the tray and within a portion of the winding cable guide that permits passage of the plurality of drop cables from the first side to the second side.

In another aspect, the fiber organizer tray further comprises a set of mounting arms extending from a hinge side of the tray configured to engage a mounting bracket.

In an alternative aspect, the second side comprises a winding cable guide that routes multiple jacketed cables a predetermined distance in a manner in which the multiple jacketed cables do not cross over themselves and do not experience a cable bend that violates a minimum bend radius of an optical fiber portion of the jacketed cable.

According to another exemplary aspect of the present invention, a telecommunication enclosure, comprises a housing, a distribution management unit disposed in the housing to access and terminate a plurality of distribution fibers, and a jacketed cable management unit disposed in the housing to organize and manage a plurality of jacketed cables to be connected to the plurality of distribution fibers, each jacketed cable including a jacketed portion that encloses an optical fiber therein. The jacketed cable management unit includes one or more fiber organizer trays hingedly coupled within the housing, wherein each of the one or more organizer trays is configured to route and provide slack storage for a plurality of jacketed cables. The fiber organizer tray includes a winding cable guide that routes multiple jacketed cables a predetermined distance in a manner in which the multiple jacketed cables do not cross over themselves and do not experience a cable bend that violates a minimum bend radius of the optical fiber portion of the jacketed cable.

In another aspect, the winding cable guide includes first and second entrances disposed on a hinge side of the organizer tray.

In another aspect, each of the one or more organizer trays includes a first side and an opposite second side, wherein the first side includes the winding cable guide and wherein the second side is configured to route and splice a plurality of the jacketed cables to a plurality of optical fiber pigtails.

In another aspect, the second side comprises a splice management insert configured to secure multiple splices formed between fiber pigtails and the plurality of jacketed cables.

In another aspect, the telecommunication enclosure further comprises a drop cable entry portion disposed in a wall of the housing and including a plurality of slots each populated with one or more cable entry devices to individually secure the plurality of jacketed cables.

In another aspect, the telecommunication enclosure further comprises a set of mounting brackets disposed in an interior portion of the housing, each of the mounting brackets configured to detachably and rotatably secure a mounting arm extending from a hinge side of the one or more organizer trays. In yet another aspect, each mounting arm comprises a pivot boss formed near an end portion thereof to be received by a correspondingly shaped receptacle formed on each of the mounting brackets. In another aspect, each of the one or more organizer trays includes stop members disposed inside the mounting arms to prevent excessive inward flexing of the mounting arms.

In another aspect, each of the one or more fiber organizer trays includes an opening formed in the tray and within a portion of the winding cable guide that permits passage of the plurality of drop cables from the first side to the second side.

In an alternative aspect, the splice management insert of at least one of the one or more fiber organizer trays receives at least one of a passive optical component and an active optical component.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1A is a top view of a telecommunication enclosure configured as a fiber distribution terminal according to an aspect of the present invention.

FIG. 1B is a top view of a telecommunication enclosure configured as a fiber distribution terminal according to another aspect of the present invention.

FIG. 1C is an isometric view of a drop cable management unit of a telecommunication enclosure configured as a fiber distribution terminal according to another aspect of the present invention.

FIG. 1D is a top view of a splice side of an exemplary fiber organizer tray showing a splice side according to another aspect of the invention.

FIG. 1E is a bottom view of the exemplary fiber organizer tray of FIG. 1D showing the slack storage side according to another aspect of the invention.

FIG. 1F is an isometric view of a distribution management unit of a telecommunication enclosure configured as a fiber distribution terminal according to another aspect of the present invention.

FIG. 2A is an isometric view of a first side of an exemplary fiber organizer tray according to another aspect of the present invention.

FIG. 2B is another isometric view of a second side of an exemplary fiber organizer tray according to another aspect of the present invention.

FIG. 3 is schematic view of an exemplary multi dwelling unit in which the telecommunication enclosure according to aspects of the present invention can be utilized.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to a fiber organizer tray and a telecommunication enclosure that includes the fiber organizer tray. The fiber organizer tray provides slack storage for jacketed cables, such as drop cables, that are routed thereon. In addition, the fiber organizer tray can further provide for splicing of the jacketed cables to optical fibers, such as optical fiber pigtails, on an opposite side of the tray. In a preferred aspect, the fiber organizer tray is implemented within a telecommunication enclosure that is configured as a fiber distribution terminal (FDT) for managing telecommunication lines, especially optical fiber telecommunication lines, in a building, such as an MDU or other location. While the embodiments herein are described with respect to an FDT implementation, the fiber organizer tray can be implemented in a telecommunication enclosure that can be configured as a different type of device, such as a fiber distribution hub (FDH) or a building entrance terminal (BET) for a small building. In addition, although the aspects described herein are directed to cables having optical fibers, the telecommunication enclosure of the present invention can also accommodate implementations that utilize hybrid and electrical cables.

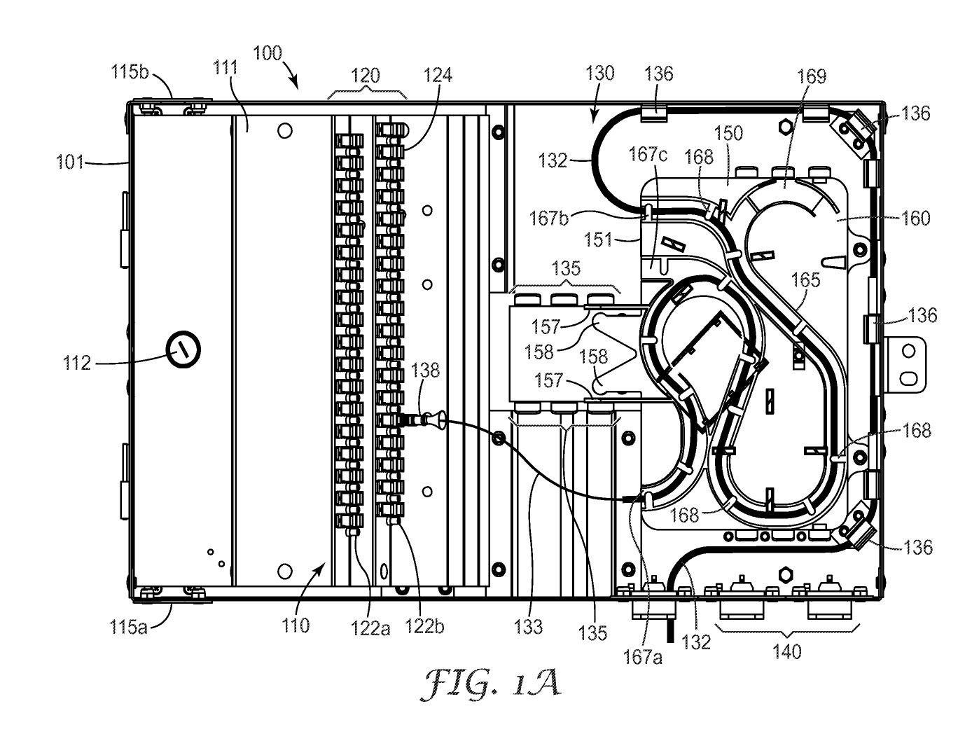

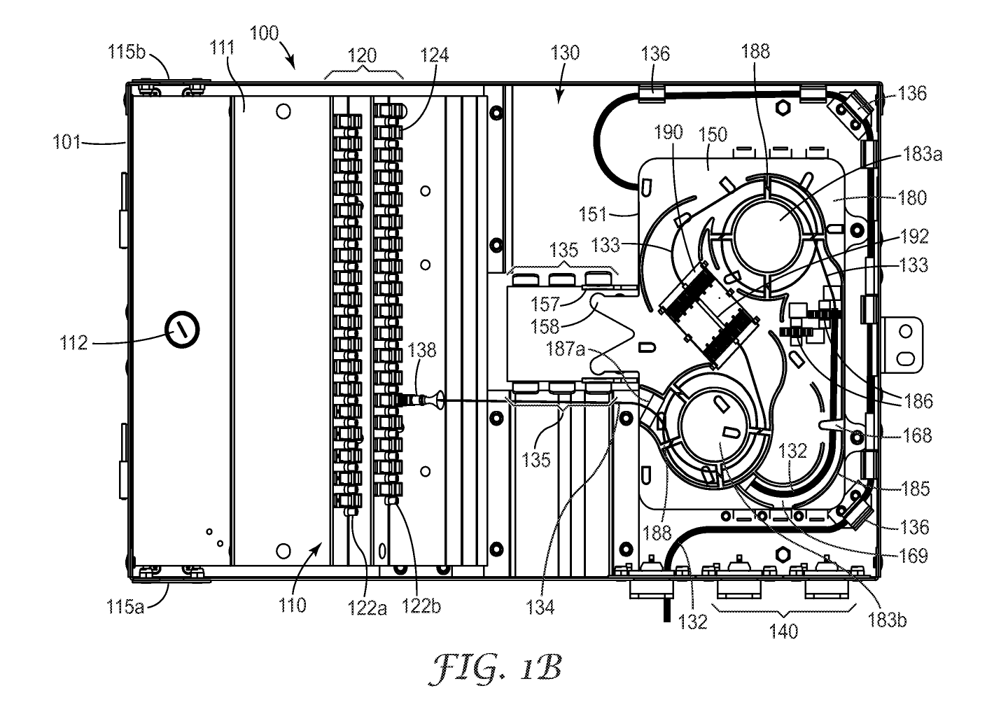

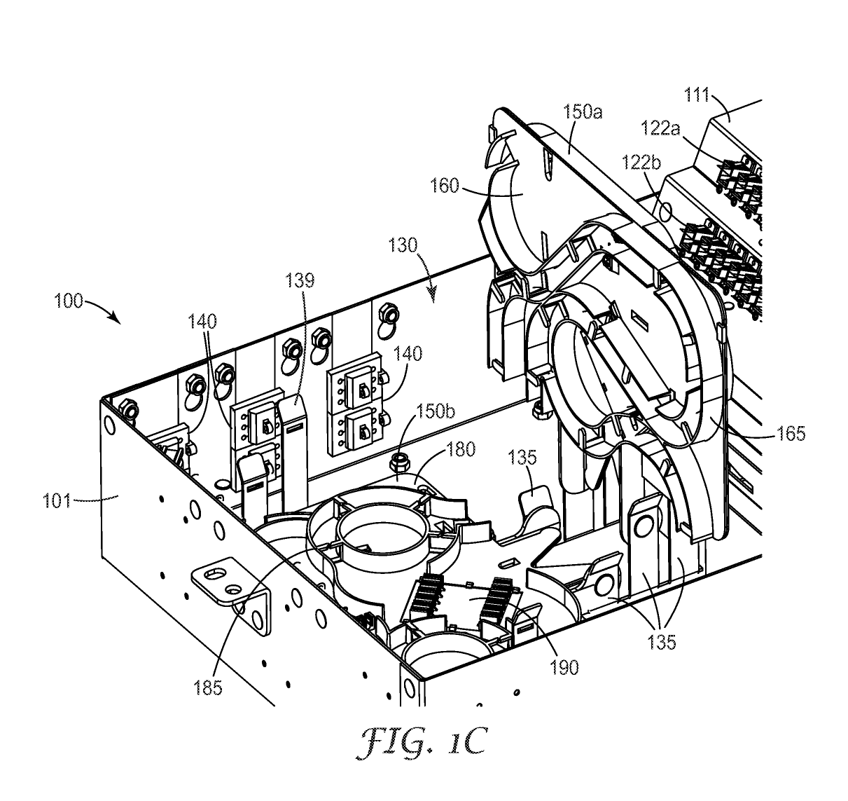

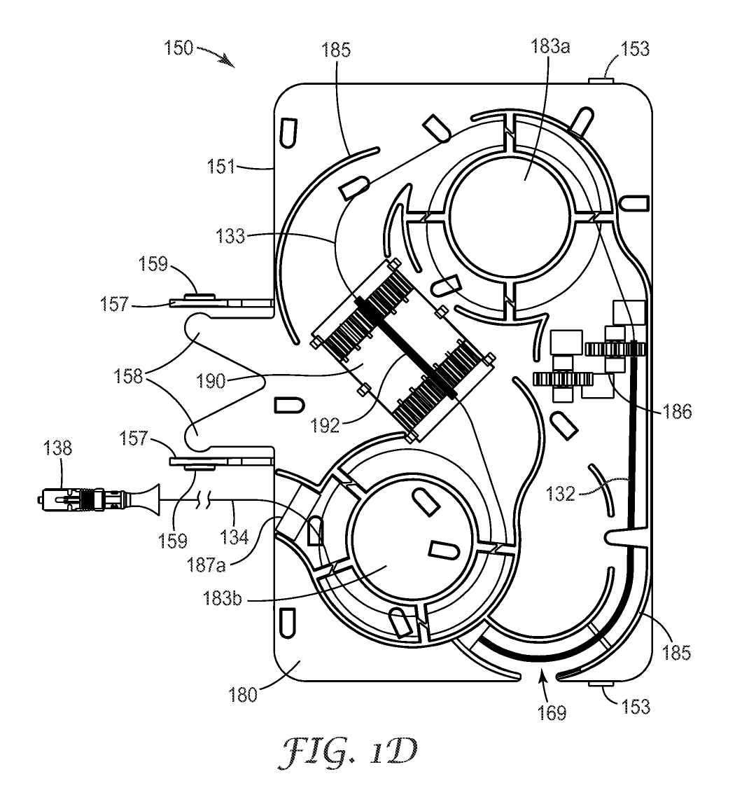

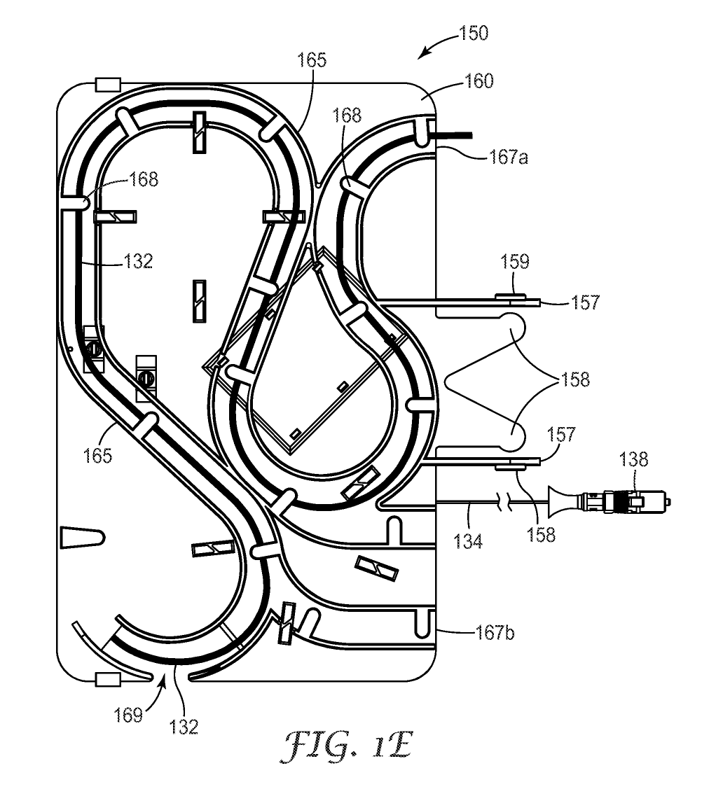

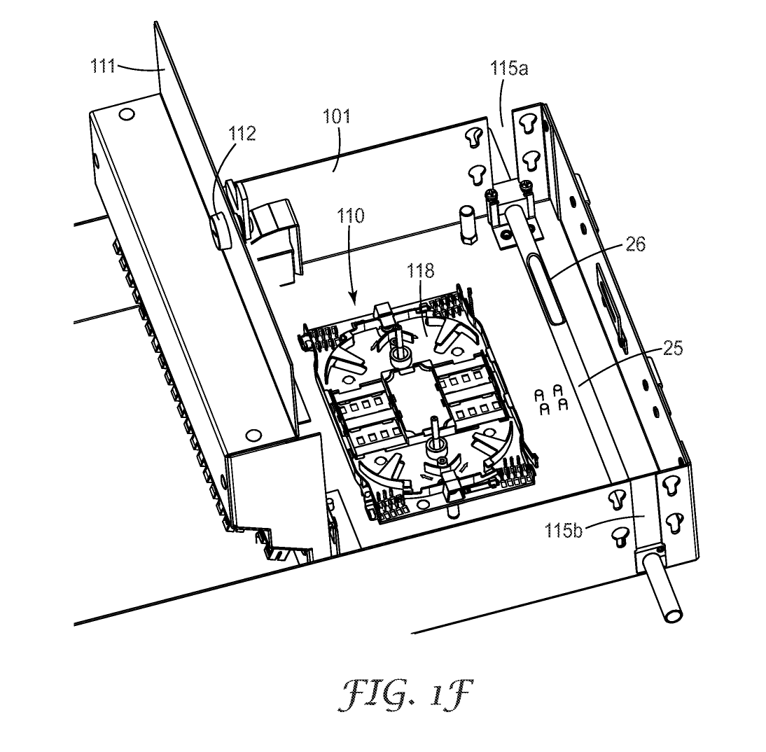

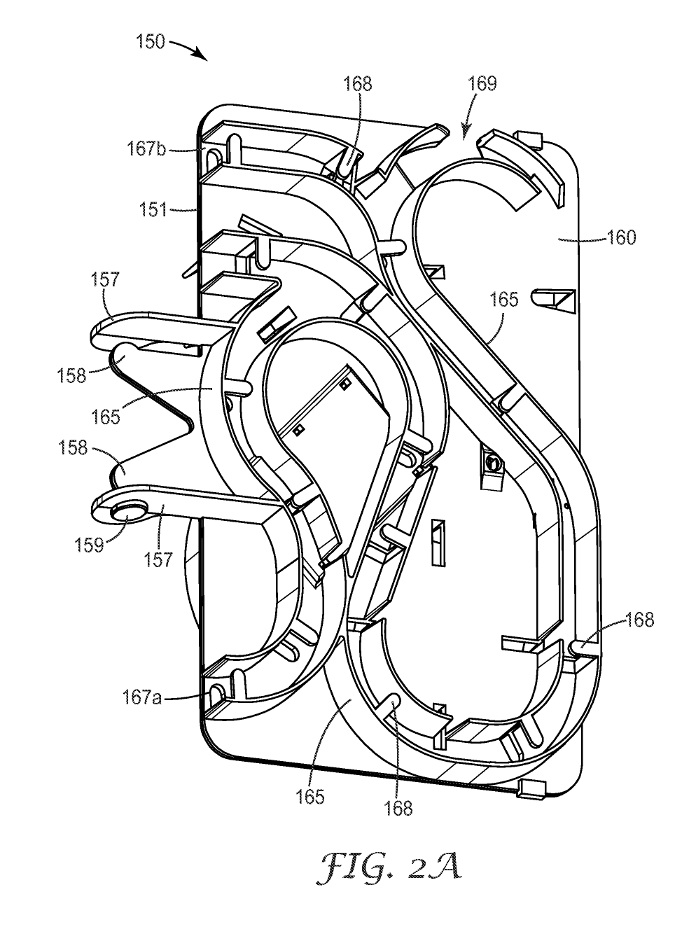

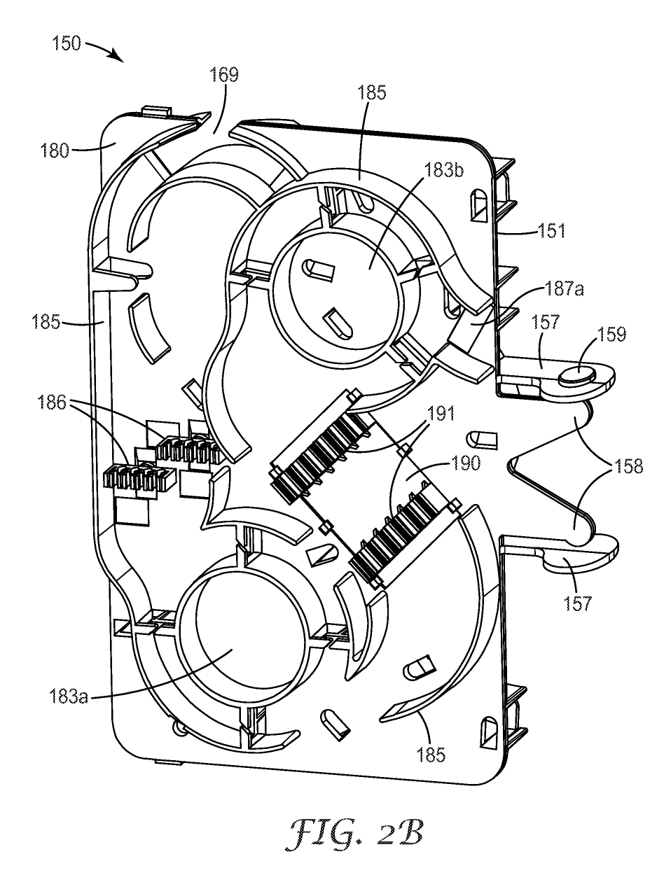

FIGS. 1A-1B show top views and FIG. 1C shows a partial isometric view of a telecommunication enclosure that includes one or more exemplary fiber organizer trays. In particular, the telecommunication enclosure of FIGS. 1A-1B is configured as a fiber distribution terminal (FDT) 100 having a fiber organizer tray 150, whereas FIG. 1C shows FDT 100 as including fiber organizer trays 150a and 150b. Close-up views of exemplary fiber organizer tray 150 are provided in FIGS. 1D, 1E, 2A and 2B.

In one aspect, FIGS. 2A and 2B show isometric views of an exemplary fiber organizer tray 150. The fiber organizer tray 150 has a generally rectangular or oblong body having a first side 160 (FIG. 2A) and an opposite second side 180 (FIG. 2B). The fiber organizer tray 150 is preferably formed from a rugged material, such as rigid plastic or metal. The first side 160 is configured to route and provide slack storage for a plurality of jacketed drop cables received on the tray. In particular, first side 160 (also referred to herein as slack storage side 160) comprises a winding or switch-back shaped cable guide 165 (referred to herein as serpentine cable guide 165).

Serpentine cable guide 165 has a square-well shaped cross-section and is configured to route multiple jacketed cables a predetermined distance on the tray 150 in a manner in which the multiple jacketed cables do not cross over themselves and do not experience a cable bend that violates a minimum bend radius of the optical fiber held within the jacketed cable. The path of serpentine cable guide 165 has multiple bends and traverses a substantial portion of side 160, and is not limited to the perimeter portions of side 160. The serpentine cable guide 165 does not have a conventional “figure-8” shape, which leads to jacketed cables crossing over themselves. In addition, the path of serpentine cable guide 165 allows jacketed cables to be routed with minimal-to-no twisting placed on the jacketed cables disposed on the fiber organizer tray 150. In addition, serpentine cable guide 165 guides the jacketed cables so that they can enter and exit along the hinge side 151 of fiber organizer tray 150. In this manner, as will be more apparent in the context of the example implementations described herein, the tray 150 can be rotated on its mount (see e.g., FIG. 1C) without placing an additional pulling force on the jacketed cables and without having the jacketed cables themselves limit rotation of an installed fiber organizer tray by entering/exiting the tray over other perimeter sides of the tray.

A shown in FIG. 2B, in a preferred aspect, the second side 180 of fiber organizer tray 150 is configured to route and splice a plurality of the jacketed cables to a plurality of optical fiber pigtails. The second side 180 can comprise a splice management insert 190 configured to secure multiple splices formed between optical fiber pigtails and the plurality of jacketed cables. Additional fiber routing structures 185 can also be included on splice side 180 to help contain and direct the fiber pigtails and jacketed cable fibers routed thereon. One or more drop cable retainers 186 cab also be provided on tray side 180 to help secure the jacketed cables. In addition, side 180 can also include one or more spools 182a, 182b to store and direct/redirect optical fibers spliced thereon.

In addition, fiber organizer tray 150 can include an opening, such as opening 169, formed in the tray 150 and within a portion of the winding cable guide 165 that permits straightforward passage of the plurality of jacketed cables from the first side 160 to the second side 180.

Further, as is shown in FIGS. 2A and 2B, the fiber organizer tray includes a set of mounting arms 157 extending from the hinge side 151 of the tray 150 that are configured to engage a mounting bracket formed in a telecommunication enclosure (described below).

In an alternative aspect, for some implementations, a fiber organizer tray having opposite sides with each side including a serpentine cable guide can be implemented. In a further alternative aspect, the first side can be implemented with a serpentine cable guide as is described above and the second side can be devoid of either slack storage or splicing features.

Further features of the exemplary fiber organizer tray 150 will be described more fully below in the context of an example FDT implementation.

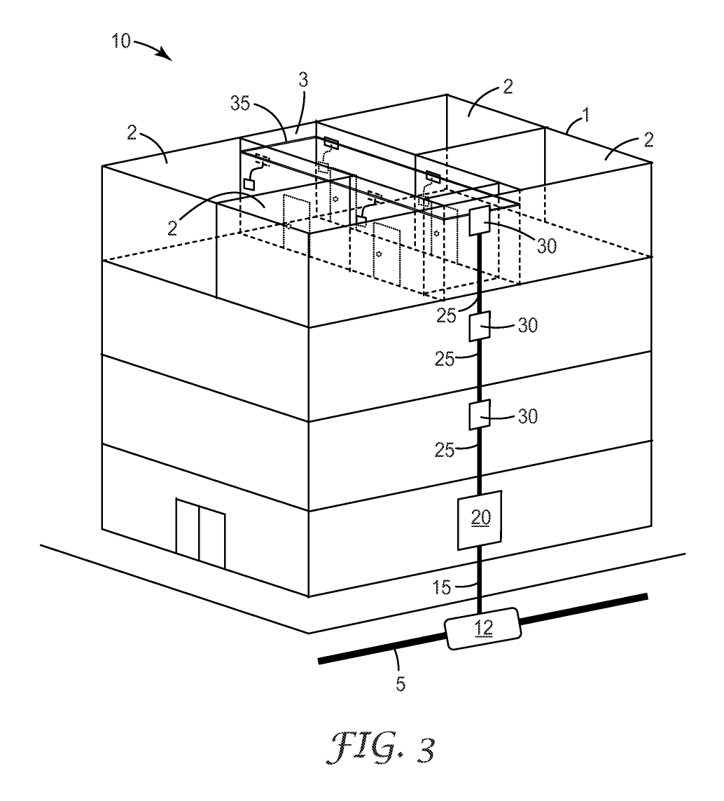

Referring to FIGS. 1A-1C, an exemplary telecommunication enclosure comprises FDT 100. FDT 100 can be mounted at a utilities access point, such as a telecommunication closet, in a building or other structure (see e.g., FIG. 3, which shows an exemplary building or MDU 10). FDT 100 can route distribution telecommunication lines, such as multiple distribution optical fibers, originating from a telecommunication service provider to individual customers living or residing within the building. FDT 100 comprises a housing or chassis 101 or other ruggedized structure that includes two distinct compartments—a distribution management unit 110 and a jacketed cable management unit 130. This compartmentalization of telecommunication line management provides for the separation of service craft. An overall cover to fully enclose chassis 101 can also be provided, but is not shown for simplicity.

In one aspect, the FDT 100 can be mounted on a wall or other generally flat surface or it can be mounted within an equipment rack. In another aspect, a wall mount bracket (not shown) with connection to ground can be provided to support FDT 100. In a further aspect, a folding work tray (not shown) can be mounted onto chassis 101 and/or stored behind the FDT 100 to provide a work bench or support for telecommunication equipment, such as a fusion splicer, often used during installation or repair.

In this exemplary aspect, distribution management unit 110 is configured to receive distribution fibers via a riser cable (see e.g., riser cable 25 shown in FIGS. 1F and 3) that can enter and exit FDT 100 via ports 115a and 115b. The multiple distribution fibers (in this specific example, 36 distribution fibers) can be accessed from the riser cable 25 using a window cut 26 (see FIG. 1F). The distribution fibers (not shown) can be pulled from the riser cable 25 and terminated at the cross connect field 120. The termination can be performed as a direct fiber termination to a cross connect field 120 (via, e.g., a conventional field mount connector) or, alternatively, through splicing the distribution fibers to fiber pigtails (not shown) which are coupled to the cross connect field 120. A splice tray for splicing the distribution fibers to pigtails can be located within the distribution management unit 110 underneath plate 111. As shown in FIG. 1F, one or more splice trays 118 can be utilized to hold the multiple splices made to the distribution fibers. A commercially available splice tray, such as a 2524-SR fiber splice tray, available from 3M Company, St. Paul, Minn., can be utilized. Alternatively, the distribution management unit 110 can utilize one or more fiber organizer trays 150 disposed therein.

Cross connect field 120 includes one or more rows (as shown in FIGS. 1A and 1B, first and second rows 122a, 122b) of couplers or adapters 124, with each coupler/adapter connected to a single distribution fiber (this connection is not shown for simplicity). These couplers/adapters 124 can also be accessed by terminated fiber drops originating from the jacketed cable management unit 130, described in further detail below. Each coupler/adapter 124 can be configured to receive a pair of standard optical fiber connectors, such as SC-type and/or LC-type connectors. In a preferred aspect, cross connect field 120 is supported by plate 111.

Once the connection of distribution fibers to the cross connect field 120 is completed, the plate 111 can be rotated from an open position (FIG. 1F) to a closed position (FIGS. 1A and 1B) and secured via a locking mechanism 112 such that distribution connections can be protected from unwanted access. As would be apparent to one of skill in the art given the present description, the communications enclosure/FDT 100 is not limited to an enclosure servicing 36 service lines and customers—the communications enclosure/FDT 100 can be modified to accommodate fewer numbers (e.g., 6, 12, 18, 24 lines) or greater numbers (e.g., 42, 48, 54, 60 lines) of service lines/customers, as is needed. In a preferred implementation, the process of fully preparing the distribution management unit 110 of FDT 100 can be completed during installation of FDT 100.

FDT 100 further includes a jacketed cable management unit 130 that is configured to receive, route, and manage a plurality of individual jacketed cables, such as drop cables, connecting the FDT 100 to individual service customers/building occupants. In a preferred aspect, the jacketed cable management unit 130 includes one or more fiber organizer trays 150, such as those described above.

Individual drop cables, such as drop cable 132 (see FIGS. 1A-1B—only one drop cable is shown for simplicity), are received at jacketed cable entry portion 140. In a preferred aspect, jacketed cable entry portion 140 comprises a plurality of slots each populated with one or more cable entry devices such as those described in the U.S. Provisional Patent Application No. 61/238,273, incorporated by reference herein in its entirety. These cable entry devices can include multiple individual ports to receive individual drop cables, such as pre-terminated drop cables, and can provide strain relief against inadvertent pulls made on the drop cables. Alternatively, the drop cable entry portion 140 can comprise a conventional multiport grommet.

Each drop cable 132 can be secured and routed within FDT 100 via cable retention structures 136 such as shown in FIGS. 1A-1B. An exemplary drop cable 132 utilized herein comprises a conventional 3 mm jacketed cable that includes a 900 μm or 250 μm buffer coated optical fiber, commercially available from a variety of sources. In an alternative aspect, drop cable 132 can comprise a drop cable having a rectangular cross section, conventionally referred to as an FRP cable.

As mentioned above, each organizer tray 150 includes a first side 160 and a second (opposite) side 180. In a preferred aspect, the first side 160 and the second side 180 each have a different fiber/cable management function. FIGS. 1A and 1B show FDT 100 as having a single organizer tray 150 in two different installed orientations (in the example for 36 drop cables, the two other organizer trays are omitted for simplicity) and FIG. 1C shows FDT 100 as having two organizer trays 150a and 150b (in the example for 36 drop cables, the third organizer tray is omitted for simplicity), with tray 150b placed in a normal use position and tray 150a rotated in a non-use position.

As explained in further detail below with respect to FIGS. 1A and 1B, fiber organizer tray 150 can be used in multiple implementations within a telecommunication enclosure, such as to accommodate pre-terminated drop cables and to accommodate drop cables to be connectorized or spliced within the enclosure.

FIG. 1A shows one example implementation where pre-terminated (or field connectorized) drop cables 132 are being connected to distribution fibers via FDT 100. Fiber organizer tray 150 includes a first side 160 that is configured to route and provide slack storage for a plurality of drop cables (only drop cable 132 is shown for simplicity). First tray side 160 (also referred to herein as slack storage side 160) faces upward and comprises a winding or switch-back shaped cable guide 165 (referred to herein as serpentine cable guide 165). As mentioned above, serpentine cable guide 165 is configured to route multiple jacketed drop cables (in this example, each tray can accommodate up to twelve (12) 3 mm jacketed drop cables) a predetermined distance on the tray 150 in a manner in which the multiple drop cables do not cross over themselves and do not experience a cable bend that violates a minimum bend radius of the drop cable.

As is also shown in FIG. 1A, drop cable 132 installed in serpentine cable guide 165 experiences multiple bends and traverses a substantial portion of side 160. When multiple drop cables are disposed in serpentine cable guide 165, the cables are not forced to cross over themselves. In addition, the path of serpentine cable guide 165 allows drop cables 132 to be routed with minimal-to-no twisting. Also, serpentine cable guide 165 guides the drop cables 132 so that they enter and exit along the hinge side 151 of organizer tray 150. In this manner, the tray 150 is rotatable on its mount (see FIG. 1C) without placing an additional pulling force on the drop cables 132 and without having the drop cables 132 themselves limit rotation of the organizer tray 150 by exiting the tray over other perimeter sides of the tray.

In the example of FIG. 1A, a terminated drop cable 132 can have a standard connectorized end (e.g., SC connector 138) that is field mounted or already terminated onto e.g., a stripped portion 133 of drop cable 132. The connector 138 can be received by an appropriate coupler 124 of the cross connect field 120. The drop cable 132 enters/exits the slack storage side 160 via a first entrance 167a (located on hinge side 151), is routed through a length of tray side 160 via serpentine cable guide 165, and exits/enters the slack storage side 160 via a second entrance 167b (also located on hinge side 151). An additional drop cable entrance/exit 167c can be provided on slack storage side 160 to be utilized in other cable routing applications. Several tabs 168 are provided on serpentine cable guide 165 and overhang portions of the guide to help retain the drop cables routed within. The exiting drop cable 132 is further secured within the main structure of FDT 100 and routed to the cable entry portion 140 via cable retention structures 136.

Thus, for applications where pre-terminated drop cables are being connected to the service provider distribution lines, only slack storage side 160 of organizer tray 150 need be utilized. For such applications, in further alternative aspects of the invention, the telecommunication enclosure can include a fiber organizer tray that is configured to route and provide slack storage for a plurality of drop cables using a serpentine cable guide—the opposite side of the fiber organizer tray can also be configured to contain a serpentine cable guide of similar shape or it can be devoid of structure as no splicing of the drop cables is required.

FIG. 1B shows another example implementation of organizer tray 150, where drop cables 132 are being spliced to fiber pigtails and connected to distribution fibers via FDT 100. Fiber organizer tray 150 includes second side 180 that is configured to route and splice a plurality of drop cables (only drop cable 132 is shown for simplicity) to a plurality of optical fiber pigtails (only one optical fiber pigtail 134 is shown for simplicity). As shown in FIG. 1B, second tray side 180 (also referred to herein as splice side 180) faces upward and comprises a splice management insert 190 that is configured to secure multiple splices 192 formed between fiber pigtails 134 and drop cables 132 (in this example, up to 12 splices can be secured to splice insert 190).

The splice management insert 190 is configured to support mechanical and/or fusion splices made to the fiber ends. In one aspect, splice management insert 190 can comprise a number of resilient clips or other holders 191 (see FIG. 2B) designed to hold one or more mechanical splices, such as 4×4 FIBRLOK™ splices (commercially available from 3M Company, St. Paul Minn.). Alternatively, holders 191 can be configured to hold one or more fusion splices. The splice management insert 190 can be formed as an integral portion of tray or it can be removable. Alternatively, the splice side 180 can be formed with appropriate receptacles to receive different splicing inserts that can be mounted to the splice side 180 of organizer tray 150, depending on the application (e.g., an insert configured to support one or more fusion splices, or a different insert to support one or more mechanical splices). In a further alternative, one or more of the trays 150 described herein may also hold passive and/or active optical components, as well as splices. In one alternative example, the splicing insert of the organizer tray 150 can house a splitter. In further alternatives, splice side 180 may be configured to hold or secure one or more of 1×N fiber optic splitters, 2×N fiber optic splitters, WDM components, CWDM components, switches, and/or other optical components combinations thereof.

The splice side 180 of tray 150 also includes first and second fiber spools 183a, 183b disposed on either side of splice management insert 190 for slack storage or redirection of the fiber pigtail 134 and the stripped portion 133 of drop cable 132. Additional fiber routing structures 185 can also be included on splice side 180 to help contain and direct the fiber pigtails 134 and drop cable fibers 133. One or more drop cable retainers 186 are also provided on tray side 180 to help secure the drop cables 132.

In the example of FIG. 1B, a fiber pigtail 134 can have a standard connectorized end (e.g., SC-type connector 138) that is received by an appropriate coupler 124 of the cross connect field 120. The pigtail 134 enters/exits the splice side 180 via a first entrance 187a (located on hinge side 151). Pigtail 134 can be spooled (if necessary) by spool 183b to store an appropriate amount of excess fiber. The splice 192 made between fiber pigtail 134 and drop cable fiber 133 can be mounted on splice insert 190. The drop cable fiber 133 can be spooled (if necessary) by spool 183a. The drop cable 132 is secured by retainer 186 and is further guided about a portion of splice side 180 via routing structures 185 to an opening 169 formed in the tray that permits the drop cable 132 to transition from the splice side 180 to the slack storage side 160.

The tray features employed when drop cables 132 are being spliced to fiber pigtails 134 are further illustrated with respect to FIGS. 1D and 1E. In particular, the orientation of organizer tray 150 as shown in FIG. 1D is the same as that shown in FIG. 1B. FIG. 1E thus shows the slack storage side 160 when viewing tray 150 from underneath the tray as it is installed. In FIG. 1D, using entrance 187a as a starting point for illustration purposes only, fiber pigtail 134 having a connector 138 (that is received by an appropriate coupler 124 as shown in FIG. 1B) enters/exits the hinge side 151 of tray 150 onto the splice side 180 via a first entrance 187a. The pigtail 134 is spooled by spool 183b and directed to the splice insert 190, where the splice 192 between optical fiber pigtail 134 and drop cable fiber 133 is held in place. The drop cable fiber is guided about a portion of splice side 180 via spool 183a to the drop cable retainers 186. The drop cable 132 is further guided via routing structures 185 to the opening 169, where drop cable 132 passes from the splice side 180 to the slack storage side 160 of tray 150.

As is shown in FIG. 1E, the spliced drop cable 132 can be further routed from the opening 169 via serpentine cable guide 165 to fiber entrance 167a. The spliced drop cable 132 can be secured within the main structure of FDT 100 and routed to the cable entry portion 140 via cable retention structures 136 (in a manner similar to that shown in FIG. 1B).

Tray 150 can be mounted within FDT 100 via a set of mounting brackets 135 (see FIGS. 1A-1C) disposed within chassis 101 to provide an offset, stacked organizer tray arrangement. Mounting brackets 135 receive pivot bosses 159 formed near the ends of mounting arms 157 of tray 150. The pivot bosses engage with correspondingly shaped receptacles (not shown) permitting (upward/downward) rotation of the organizer tray 150. Mounting arms 157 are preferably constructed from a rigid material that also permits some modest flexing at the outer ends to allow straightforward attachment to the mounting brackets 135. Stops 158 can also be provided on tray 150 to prevent excessive inward flexing of the mounting arms 137 that may damage the arms after repeated flexing. In alternative aspects, the attachment of the trays to the chassis may be modified, as would be apparent to one of ordinary skill in the art given the present description. With this construction, organizer tray 150 can be inserted in two different orientations within FDT 100, one orientation with slack storage side 160 facing upwards (see FIG. 1A) or another orientation with splice side 180 facing upwards (see FIG. 1B). This overall system flexibility allows FDT 100 to be utilized in several different applications, as is described above.

In the example shown in FIG. 1C, the tray 150a is rotated 90° with respect to tray 150b. In this manner, a technician can access either side of tray 150a, 150b during installation, customer hookup/disconnection or repair. In addition, each tray 150 may further include a tab 153 or similar structure that engages a tray retention structure 139 formed in the chassis to secure the tray 150 in its “in use” position and prevent inadvertent rotation of the tray. Other retention structures may also be utilized.

Also, the drop cables and/or pigtails enter/exit organizer trays 150 via hinge side 151, thus reducing the risk of unwanted pulls being placed on the fibers during installation and repair processes. Although not shown, jacketed cable management unit 130 may further include a movable cover or plate that is closed and secured when an installation, customer hookup/disconnection or repair process is completed, in a manner similar to that with the distribution management unit.

FIG. 3 shows an example a multi-dwelling unit (MDU) or building 10 having a fiber distribution hub (FDH) as well as a fiber distribution terminal (FDT). The MDU 10 is a multi-floor structure having a plurality of living units 2 located on each floor thereof. One example floor 1 has four living units 2 having a common hallway 3.

A feeder cable 5 brings communications lines to and from building 10. These communications lines are spliced to building feeder lines 15 of the MDU cabling at a splice closure 12. The building feeder lines 15 are distributed to the building from the FDH 20 through riser cables 25 which run to the FDTs 30 located on each floor of the MDU 10 (in some buildings FDTs are placed on every other floor). Exemplary strain relief devices, such as those described in the U.S. Provisional patent application Ser. No. 12/238,273, cited above, can be used to secure the riser cables 25 in the entrance (exit) portion of the FDH 20. Additionally, exemplary strain relief devices may be used as cable entry portions (see exemplary cable entry portions 140 described above) in the FDTs 30 on each floor to secure the telecommunication drop cables 35 that exit the FDT and run to each living unit 2. Alternatively, in a direct run architecture, all of the telecommunication drop cables may run from the FDH to the individual living units on each floor of the MDU. Thus, the exemplary telecommunication enclosures 100 described above can be utilized as either an exemplary FDH or FDT in this exemplary MDU.

Thus, the telecommunication enclosure and fiber organizer trays described herein can be utilized in multiple telecommunication service functions for MDUs or other buildings, such as FDT implementations and FDH implementations.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. A fiber organizer tray, comprising:
a generally rectangular or oblong body having a first side and an opposite second side, wherein the first side is configured to route and provide slack storage for a plurality of jacketed cables, wherein the first side further includes a winding cable guide that routes multiple jacketed cables a predetermined distance in a manner in which the multiple jacketed cables do not cross over themselves and do not experience a cable bend that violates a minimum bend radius of an optical fiber portion of the jacketed cable.

2. The fiber organizer tray according to claim 1, wherein the second side is configured to route and splice a plurality of the jacketed cables to a plurality of optical fiber pigtails.

3. The fiber organizer tray of according to claim 2, wherein the second side comprises a splice management insert configured to secure multiple splices formed between the optical fiber pigtails and the plurality of jacketed cables.

4. The fiber organizer tray according to claim 1, further comprising an opening formed in the tray and within a portion of the winding cable guide that permits passage of the plurality of drop cables from the first side to the second side.

5. The fiber organizer tray according to claim 1, further comprising a set of mounting arms extending from a hinge side of the tray configured to engage a mounting bracket.

6. The fiber organizer tray according to claim 1, wherein the second side comprises a winding cable guide that routes multiple jacketed cables a predetermined distance in a manner in which the multiple jacketed cables do not cross over themselves and do not experience a cable bend that violates a minimum bend radius of an optical fiber portion of the jacketed cable.

7. A telecommunication enclosure, comprising:
a housing;
a distribution management unit disposed in the housing to access and terminate a plurality of distribution fibers; and
a jacketed cable management unit disposed in the housing to organize and manage a plurality of jacketed cables to be connected to the plurality of distribution fibers, each jacketed cable including a jacketed portion that encloses an optical fiber therein, wherein the jacketed cable management unit includes one or more fiber organizer trays hingedly coupled within the housing, wherein each of the one or more organizer trays is configured to route and provide slack storage for a plurality of jacketed cables, wherein the fiber organizer tray includes a winding cable guide that routes multiple jacketed cables a predetermined distance in a manner in which the multiple jacketed cables do not cross over themselves and do not experience a cable bend that violates a minimum bend radius of the optical fiber portion of the jacketed cable.

8. The telecommunication enclosure according to claim 7, wherein the winding cable guide includes first and second entrances disposed on a hinge side of the organizer tray.

9. The telecommunication enclosure according to claim 7, wherein each of the one or more organizer trays includes a first side and an opposite second side, wherein the first side includes the winding cable guide and wherein the second side is configured to route and splice a plurality of the jacketed cables to a plurality of optical fiber pigtails.

10. The telecommunication enclosure according to claim 9, wherein the second side comprises a splice management insert configured to secure multiple splices formed between fiber pigtails and the plurality of jacketed cables.

11. The telecommunication enclosure according to claim 7, further comprising a drop cable entry portion disposed in a wall of the housing and including a plurality of slots each populated with one or more cable entry devices to individually secure the plurality of jacketed cables.

12. The telecommunication enclosure according to claim 7, further comprising a set of mounting brackets disposed in an interior portion of the housing, each of the mounting brackets configured to detachably and rotatably secure a mounting arm extending from a hinge side of the one or more organizer trays.

13. The telecommunication enclosure according to claim 12, wherein each mounting arm comprises a pivot boss formed near an end portion thereof to be received by a correspondingly shaped receptacle formed on each of the mounting brackets.

14. The telecommunication enclosure according to claim 12, wherein each of the one or more organizer trays includes stop members disposed inside the mounting arms to prevent excessive inward flexing of the mounting arms.

15. The telecommunication enclosure according to claim 9, wherein each of the one or more fiber organizer trays includes an opening formed in the tray and within a portion of the winding cable guide that permits passage of the plurality of drop cables from the first side to the second side.

16. The telecommunication enclosure according to claim 10, wherein the splice management insert of at least one of the one or more fiber organizer trays receives at least one of a passive optical component and an active optical component.
